(19) United States
(12) Patent Application Publication
(10) Pub. No.: US 2024/0351122 A1
(43) Pub. Date: Oct. 24, 2024

(54) GEAR-CUTTING MACHINE, MORE PARTICULARLY SKIVING MACHINE, HAVING A TOOL CHANGING SYSTEM

(71) Applicant: Profilator GmbH & Co. KG, Wuppertal (DE)

(72) Inventor: Malte KUNSTMANN, Wuppertal (DE)

(73) Assignee: Profilator GmbH & Co. KG, Wuppertal (DE)

(21) Appl. No.: 18/684,210

(22) PCT Filed: Aug. 16, 2022
(86) PCT No.: PCT/EP2022/072849

§ 371 Date: Feb. 16, 2024

(30) Foreign Application Priority Data
Aug. 16, 2021 (DE) 10 2021 121 245.6

(51) Int. Cl. B23F 5/16; B23F 23/12

(52) U.S. Cl. CPC B23F 5/163; B23F 23/1206; B23F 23/1237

(57) ABSTRACT

A skiving machine has a workpiece spindle and a tool spindle for holding a work wheel to undergo gear cutting, which tool spindle can be rotationally driven synchronously with the workpiece spindle. The workpiece is inclined at an axis intersection angle with respect to the tool spindle for holding a tool retainer. A tool changing system fastened to a housing of the tool spindle is provided, and has a tool carrier, which can be rotated about a tool-carrier axis of rotation and which has carrying plates rotationally arranged around the tool-carrier axis of rotation, each carrying plate having a bearing opening for holding a tool retainer carrying a skiving tool, wherein tool retainers supported in the bearing openings can be selectively coupled to the tool spindle rotation of the tool carrier about the axis of rotation.

### CROSS REFERENCE TO RELATED APPLICATIONS

This application is the National Stage of PCT/EP2022/072849 filed on Aug. 16, 2022, which claims priority under 35 U.S.C. § 119 of German Application No. 2021 121 245.6 filed on Aug. 16, 2021, the disclosure of which is incorporated by reference. The international application under PCT article 21 (2) was not published in English.

### Field OF THE TECHNOLOGY

The invention relates to a gear-cutting machine with a rotatable workpiece spindle, which can be rotationally driven, and a tool spindle, which can be rotationally driven synchronously with the workpiece spindle, wherein the workpiece spindles carrying a work wheel to undergo gear cutting is arranged, in particular, inclined at an axis intersection angle with respect to the tool spindle for holding a tool retainer, wherein the tool retainer holds a tool, for example, a skiving tool, with cutting edges formed by cutting teeth.

### PRIOR ART

Gear skiving machines are known from DE 10 2009 025 945 A1, U.S. Pat. No. 3,264,940, EP 3 546 101 A1 or EP 2 520 391 B1. Tool changing systems are known from DE 10 2015 013 133 A1, DE 10 2016 001 804 A1 and DE 101 30 446 A1.

From DE 10 2017 213 361 B4, there is a known gear-hobbing machine in which a toothing can be machined into a workpiece using a hobbing head. With two chamfering tools supported by a rotatable holder, the toothing can be chamfered.

DE 10 2012 104 491 A1 describes a tool carrier system with a drum-shaped magazine for holding interchangeable tools, wherein one exemplary embodiment of the drum-shaped tool magazine also has pyramid-like surfaces to which tools are fastened.

EP 3 272 448 A1 describes a method for hard skiving of case-hardened workpieces. One of the methods described there requires the use of two different skiving tools. Even with other types of machining, for example, if a shaft with two different toothings is to be produced, the use of two different skiving tools can be necessary. In the case of prior art, a plurality of tool spindles are used for this purpose, or a tool change takes place in which a tool retainer carrying one tool is exchanged for a tool retainer carrying another tool. This is done by shifting the tool spindle within the housing of the machine tool or by using a suitable gripping tool.

US 2021/0245278 A1 describes a device for creating bevels with a tool head carrying two tools and fastened to a tool carrier in a rotatable manner. The chamfering tool can be used as an additional unit on a toothing machine.

U.S. Pat. No. 5,730,691 A describes a tool changing system in which a plurality of tool retainers are arranged on a conical carrier, which carry end milling cutters, drills or other tools that can be moved into a working position by rotating the tool carrier in which the tool retainer can be coupled to a drive spindle.

US 2011/0229282 A1 describes a method for gear-cutting movement wheels with a plurality of workpieces arranged on a rotating disc, which can be machined sequentially at different positions by different tools.

EP 1 083 026 A2 describes a tool changing system for drills or end milling cutters.

### SUMMARY OF THE INVENTION

The object of the invention is to improve the performance of a gear-cutting machine in which a plurality of different tools are used for the machining of workpieces.

The task is achieved by means the invention specified in the claims, wherein the sub-claims are not only favourable further embodiments of the invention, but also represent independent solutions to the task at hand.

First and essentially, it is proposed that a tool changing system is fastened to a housing of the tool spindle. The tool changing system has a tool carrier that carries a plurality of tools. In particular, it is provided that the tool carrier will carry a plurality of tool retainers, wherein one of the tool retainers preferably holds a skiving tool. It can also be provided that each of the tool retainers holds a skiving tool. However, it is also provided that the tool retainer will carry other tools, each of which has one or a plurality of chip edges in order to machine the workpiece. For this purpose, the tool retainer can have a chuck that carries the tool assigned to it. The tool retainers can have the same shape as each other and, in particular, have a coupling section that can be coupled to a chuck of the tool spindle. In particular, the chuck is located at one end of a drive shaft of the tool spindle. The coupling section can be slightly tapered and connected to the chuck via an axial movement. A clamping device can be provided with which the tool retainer can be firmly connected to the drive shaft of the tool spindle. The clamping device can be released from a clamped position. In this release position, the tool retainer can be pulled out of the chuck in the axial direction with respect to the tool axis of rotation. Starting from an first tool retainer, which is coupled to the tool spindle, the first machining step is to carry out an first machining, such as the gear-cutting of a non-toothed blank or a fine machining of a pre-toothed blank for example. The tool spindle is moved into a tool change position, in which the tool assumes a distant position from the workpiece. A clamping device that holds the tool retainer on the tool spindle is released. With the locking means, the tool retainer is temporarily fixed to the tool carrier. The tool carrier is shifted linearly in relation to the tool spindle so that the tool retainer detaches from the tool spindle. The tool carrier is rotated until another tool retainer has entered the tool axis of rotation. The tool carrier is moved linearly back with relation to the tool spindle so that the tool retainer enters a coupling position to the tool spindle. The locking means are released. The tool retainer can be clamped.

The tool carrier can be rotated about an axis of rotation. It can be moved about the axis of rotation into different rotation positions. The plurality of tool retainers are arranged about the axis of rotation. The tool carrier comprises suitable holding devices for this purpose. In each of the different rotation positions, a holder aligns with the chuck of the tool spindle. The holders prefer to form bearing openings. One tool or one tool retainer can be held in each of the bearing openings. Suitable retaining means are provided for this purpose.

The tool carrier can be shifted in one direction parallel to the tool axis of rotation in relation to the housing of the tool spindle. For this purpose, a lifting device can be provided which is fastened to the housing of the tool spindle and which can have a thrust rod that can engage with the tool changing system. For this purpose, the tool changing system can comprise a section that is guided by a housing-fastened guide in the direction of the tool axis of rotation. The lifting device allows this section to travel back and forth between two positions. In a lowered position, a tool retainer in a machining position can be coupled to the drive shaft of the tool spindle. In a raised position, the tool retainer can be disconnected from the drive shaft. In the raised position, the tool carrier can be rotated about the axis of rotation by an angle of rotation in such a way that another tool retainer comes into an alignment position with the drive shaft. By shifting the tool changing system to the lowered position, this tool retainer is then coupled to the drive shaft. In particular, it is provided that the tool changing system fastened to the housing of the tool spindle comprises a plurality of carrying plates, each of which will comprise a bearing opening for holding a skiving tool or a tool retainer which carries a skiving tool. Tool retainers supported in the bearing openings can be coupled selectively to the tool spindle by means of rotation of the tool carrier about the axis of rotation and by shifting the tool carrier linearly in the direction of the tool axis of rotation. The coupling that allows the tool retainer to be coupled to the tool spindle can be a standard coupling that comprises a polygonal surface arrangement for example. The tool retainer can be a “Capto holder”.

In accordance with a further embodiment of the invention, the tool carrier of the tool changing system is designed to be a truncated pyramid-like structure. In principle, however, the tool carrier can also be drum-shaped. The carrying plates preferably form the lateral surfaces of a truncated pyramid. The carrying plates can have a rectangular or trapezoidal layout. Four carrying plates can be provided, which are arranged in an even angular distribution about the axis of rotation. The axis of rotation runs centrally and perpendicularly through a head surface of the truncated pyramid. Two carrying plates facing each other in relation to the axis of rotation can have an angle of 90 degrees or a plurality of to each other. The axis of rotation comprises such an inclination to the tool axis of rotation that a carrying plate assuming a machining position extends transversely to the tool axis of rotation. It can be 45 degrees. The surface normal of this carrying plate then runs in the direction of the tool axis of rotation. A carrying plate that does not assume the machining position then runs at a right angle or at a different angle to the carrying plate assuming the machining position. The angle depends on the number of carrying plates. If the tool carrier has more than four carrying plates, each with a bearing opening, the angle of the carrying plate with respect to the axis of rotation is greater than 45 degrees.

A variant of the invention concerns an improvement of the temporary holder of the tool retainer in the bearing opening. The shaft of the tool retainer can be inserted into the bearing opening with radial play in such a way that the tool retainer can rotate in relation to the carrying plate. The carrying plate can have locking means with which the tool retainer is temporarily tied to the carrying plate, namely whenever the tool retainer is not coupled to the drive shaft of the tool spindle. The locking means can be designed as a slider. The slider can be shifted back and forth between a locking position and a release position. In the locking position, the tool retainer is axially fastened to the carrying plate. In the release position, the tool retainer can be removed from the bearing opening. It can also be provided that the tool retainer is torque-proof in the locking position in relation to the carrying plate. The locking means can also tie the tool retainer to the carrying plate in a torque-proof manner. In the release position, however, the tool retainer can rotate freely in the bearing opening. A spring element can be provided which impinges the locking means into the locking position. The locking means can be held in the locking position by two interconnected locking elements. The locking elements can have parallel locking flanks, wherein the locking flanks can also comprise free spaces. In the locking position, the locking flanks are preferably located in a recess in the shaft of the tool retainer. In the release position, the shaft of the tool retainer lies in the free spaces. The locking elements can be formed by rods that run parallel to each other. The two rods can have a round profile. The two rods can be connected to each other at their two ends with a bracket or a connecting element. The locking means can have a stop which, in the locking position, abuts a counter stop on the shaft of the tool retainer. Preferably, the stop enters into an indentation in the locking position. The stop can be supported at the bottom of the indentation. In such an arrangement, the indentation can also be formed by an annular groove. However, the indentation can also simply be a secant-shaped cut-out in the shaft of the tool retainer. In particular, it is provided that four indentations are arranged at an even angle around the centre of the shaft and that the bottoms of the indentations extend in a straight line. The spring element that impinges the locking means in the locking position can be tensioned by an actuating element to move the locking means into the release position. For this purpose, an actuating element not fastened to the carrying plate can be provided. The actuating element can be fastened to the housing of the tool spindle. In particular, a holding arm can be provided with which the actuating element is fastened to the housing. The actuating element can have a slider that couples with the locking means during the course of the lifting movement of the tool carrier from the raised to the lowered position. A slider of the actuating element can be disconnected from the locking means when the tool carrier is lifted.

A guide body, such as a guide ring for example, can be provided on the carrying plate to guide at least one locking element of the locking means. The guide body can be formed by a ring-shaped body that is firmly connected to the carrying plate. The guide body can have channels in which the locking elements of the locking means are guided. The channels can cut the circular free space of the guide ring. The shaft of the tool retainer lies in the circular free space of the guide body with movement play and is tied to the guide body exclusively by means of positive-locking means engaging into indentations in the direction of the axis and/or direction of rotation.

One variant of the invention concerns the assignment of a supplementary tool to the tool carrier. In this aspect of the invention, a supplementary tool is assigned to each bearing position of a tool on the tool carrier, i.e., preferably to each carrying plate or each bearing opening. The supplementary tool can be fastened to the carrying plate. However, it can also be provided that the supplementary tool is fastened to an intermediate plate that extends between two carrying plates that are adjacent in the circumferential direction-in relation to the axis of rotation. The supplementary tool can have a coupling means that can be engaged with a counter coupling means when coupling the tool retainer with a chuck of the drive shaft of the tool spindle. The coupling devices can thus be moved from a clutch position to a non-coupled position by linearly shifting the tool changing system. The counter coupling means are preferably firmly connected to the housing of the tool spindle. In a preferred embodiment of the invention, the supplementary tool is a fluid nozzle with which a fluid, such as air or a liquid for example, can be moved against the work wheel to be machined. The coupling means can be a tube section. The counter coupling means can be a sleeve. In particular, it is provided that when the tool carrier is shifted axially, the supplementary tool will be coupled or decoupled to/from a supply line for a gas or liquid. For this purpose, the shaft of the tool retainer preferably runs parallel to the direction of extension of the supply line in the area of the coupling point or parallel to the axes of a tube section or a sleeve section, which enter into a gas-or liquid-carrying connection with each other when the tool carrier is lowered. However, the supplementary tool can also be a dental tool.

In addition, the invention relates to a method for the gear cutting of non-toothed or already pre-toothed workpieces. The device used for this purpose has a workpiece spindle that has a chuck that can hold a workpiece. The workpiece spindle can be rotated about a workpiece spindle axis of rotation. The tool spindle or the workpiece spindle is spatially shifted linearly or around axes of rotation in order to be able to adjust the relative position of the tool spindle and workpiece spindle. In skiving, the tool spindle axis and the workpiece spindle axis are at an angle to each other. An axis intersection angle defines either an inclination position of the tool to the workpiece, with which a cutting angle can be adjusted, or, depending on the chip surface offset, an angle of attack with which the cutting edges of the cutting teeth of the skiving wheel attack the workpiece by skiving. If skiving is to be carried out with the respective tool, the workpiece spindle and the tool spindle are moved into a suitable axis intersection angle. If a different machining is to be carried out with a different tool, the angle between the workpiece spindle and the tool spindle is changed. Machining operations can be provided in which the workpiece spindle and tool spindle have parallel axes to each other, for example, if an undercut is to be machined into an internal toothing. By means of a synchronized rotational movement of the tool spindle axis and the workpiece spindle axis and a simultaneous feed, either in the cutting direction of the cutting edges for roughing or in the opposite direction to fine machining, the workpiece is toothed or tooth flanks of a toothed workpiece, for example an case-hardened workpiece, are post-processed. In particular, post-processing can be carried out with mirror-symmetric tools. In particular, straight-toothed movement wheels can be finely machined in such a way that the left tooth flanks are first machined with a first tool and the right tooth flanks are first machined with a second tool. The tool change is carried out by an first lifting movement of a lifting device, with which the tool retainer assuming the machining position is detached from the tool spindle, a subsequent rotational movement, which is used to move another tool retainer into a machining position, and a further lifting movement, which connects the tool retainer to the tool spindle. It is considered favourable if the locking means fix the tool retainers at their bearing position on the tool carrier due to a spring preload and if the locking means are moved into a release position by an actuating element not assigned in the tool changing system, wherein it is favourable if the actuating element with the locking means automatically couples in the event of a linear shift of the tool changing system in relation to the housing of the tool spindle coupling. In accordance with a preferred embodiment of the invention, the method comprises at least two method steps in which the workpiece is skiving with different skiving tools. In an alternative method, a skiving step can be followed by another method step using a roofing tool, a depositing tool, a universal milling tool or a drilling tool. This additional tool is fastened to a holder that is inserted into a bearing opening of the tool carrier. A plurality of such tools, especially different ones, can be inserted into a plug-in opening of the tool carrier, each with a holder.

### BRIEF DESCRIPTION OF THE DRAWINGS

An exemplary embodiment of the invention is explained below by means of fastened drawings. The figures show:

FIG. 1 a section from a perspective illustration of a machine tool with a workpiece spindle 1 and a tool carrier 13, which carries four tool retainers 6, each equipped with a skiving tool 7, wherein a tool retainer 6 located in a machining position can be rotated by a tool spindle, which can also be pivoted around a pivot axis S,

FIG. 2 the section in accordance with section line II in FIG. 4, wherein the projections of the axes R1 and R2 are parallel in the paper plane and the tool retainer 6 is coupled to the drive shaft 42,

FIG. 3 shows a partially sectioned view of the tool spindle 5 in accordance with arrow III in FIG. 1, wherein the tool axis of rotation R2 runs parallel to the paper plane,

FIG. 4 shows another view similar to FIG. 3, but from a different perspective, wherein the workpiece axis of rotation R1 runs parallel to the paper plane and the workpiece axis of rotation R1 is inclined by an axis intersection angle α with respect to the tool axis of rotation R2,

FIG. 5 a view of the tool carrier 13 from below,

FIG. 6 shows an illustration in accordance with FIG. 2, wherein the tool retainer 6 is decoupled from the drive shaft 42,

FIG. 7 a sectional illustration of the operating position in accordance with FIG. 6 in accordance with section line VII-VII in FIG. 6,

FIG. 8 a perspective illustration of an arrangement of a sector of a tool carrier 13 of a tool changing system 12 with a tool retainer 6 and a supplementary tool 21,

FIG. 9 a further section through the tool axis of rotation R2 to illustrate the operation of a locking means 13 with which the shaft of a tool retainer 6 can be fastened in a bearing opening 17

FIG. 10 shows a guide ring 39 forming the bearing opening 17 and firmly connected to a carrying plate 14, which guides the locking means 18,

FIG. 11 shows a cross-section of the guide ring 39 in a locking position of the locking means 18 and

FIG. 12 an illustration in accordance with FIG. 11 in the release position of the locking means 18.

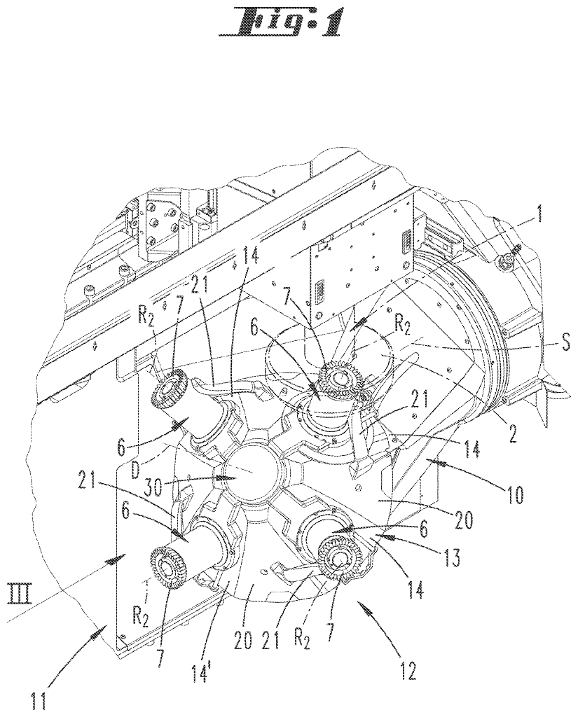

### DESCRIPTION OF THE EMBODIMENTS

The exemplary embodiment shown in the drawings is a gear skiving machine with which non-toothed blanks 3 can be provided with a tooth 4. Both internally toothed blanks 3 as well as externally toothed blanks can be toothed. This can be done selectively with one of a plurality of skiving tools 7 in the skiving process. With regard to the special feature of the gear skiving process and its technical differentiation from other cutting processes, reference is made to the above-mentioned prior art. It is essential that a skiving tool 7 with cutting teeth 8 is rotated about an oblique axis of rotation R1 of a work wheel 3 and advanced in the direction of extension of the teeth to be manufactured in such a way that the cutting edges 9 of the cutting teeth 8 engage in the work wheel 3 by skiving. In contrast to hobbing, in which the cutting edges of a plurality of cutting teeth arranged one behind the other plunge into the same tooth gap, skiving is carried out with the cutting edges arranged on the front side of a gear-like tool.

A workpiece spindle 1 has a rotary drive with which a work wheel 3 can be rotated about a workpiece axis of rotation R1. The tool spindle 1 can be fastened linearly in a Y-direction or an X-direction, for example, on the machine bed 11. A holder 10 can be fastened to the machine frame around a pivot axis S. The holder 10 can support a tool spindle 5. The tool spindle 5 or the tool axis of rotation R2 can therefore be placed in an angular position in relation to the work wheel 3 and in an angular position in relation to the workpiece axis of rotation R1.

The tool spindle 5 has a housing 16. A guide 26 is fastened to the housing 16. The guide 26 has a cylinder 28 in which a piston 27 is guided. A piston rod 29 is fastened to the piston 27, which forms a thrust rod 29. The thrust rod 29 engages a section 46 of a tool changing system 12 in order to shift the tool changing system 12 in one direction parallel to the tool axis of rotation R2 in relation to the housing 16. The guide can have one or a plurality of, preferably two, parallel guide rails.

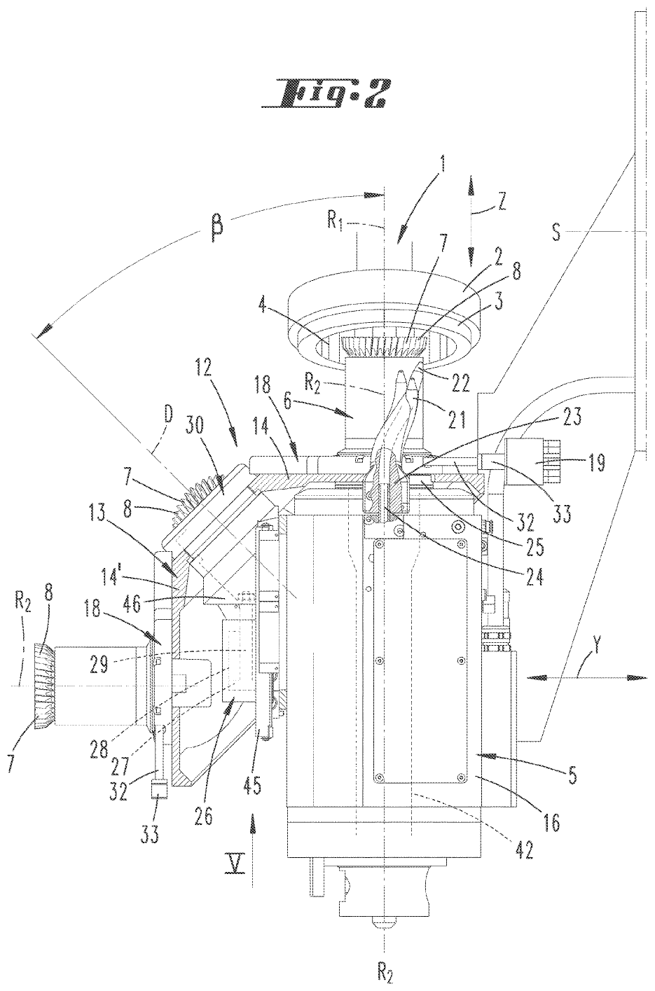

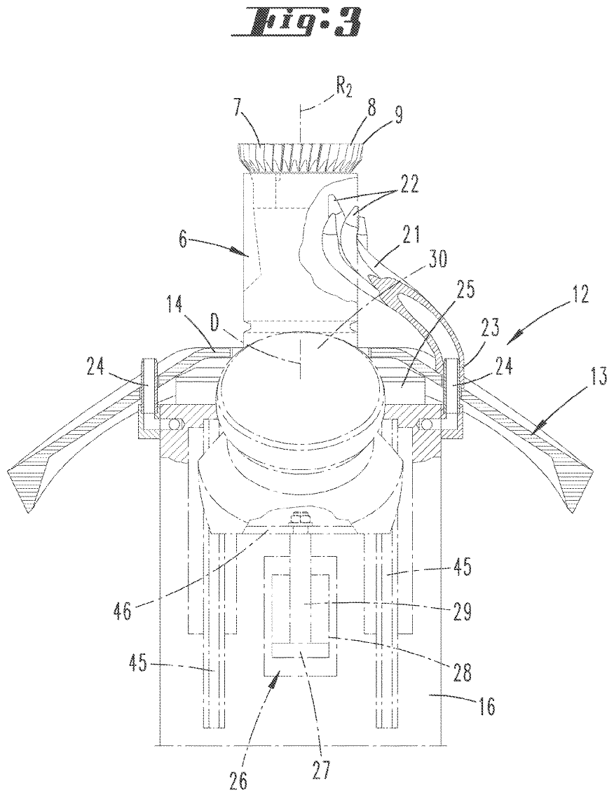

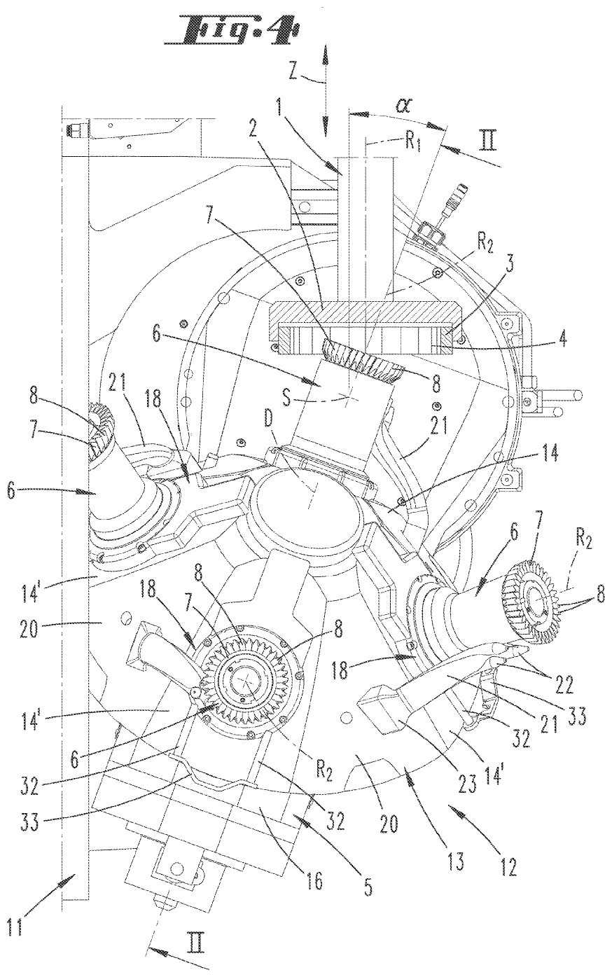

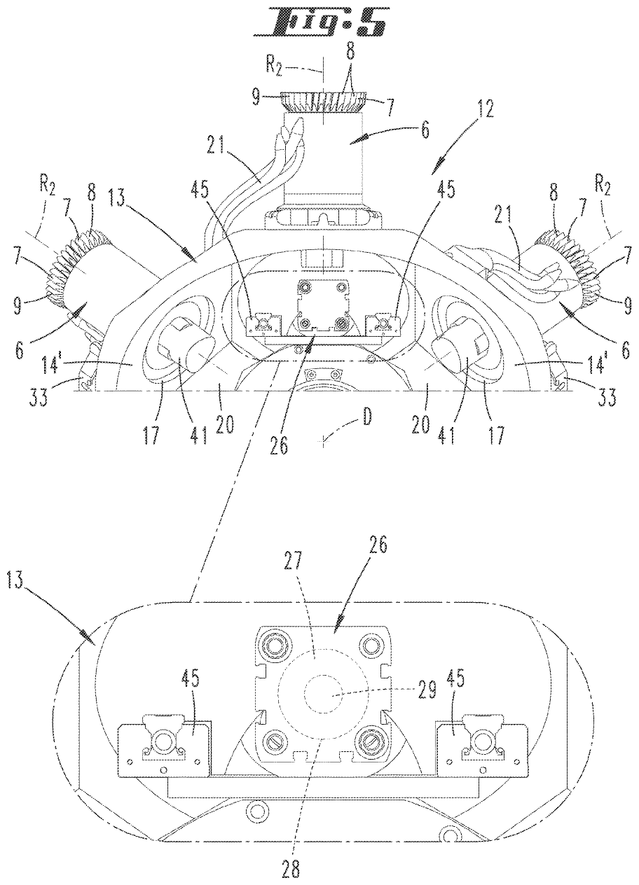

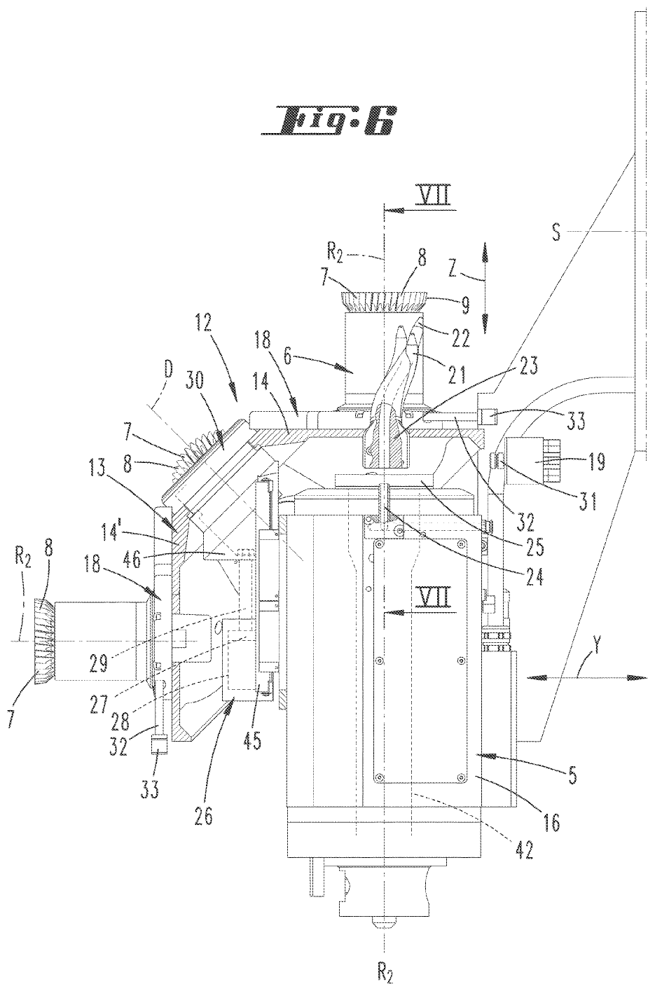

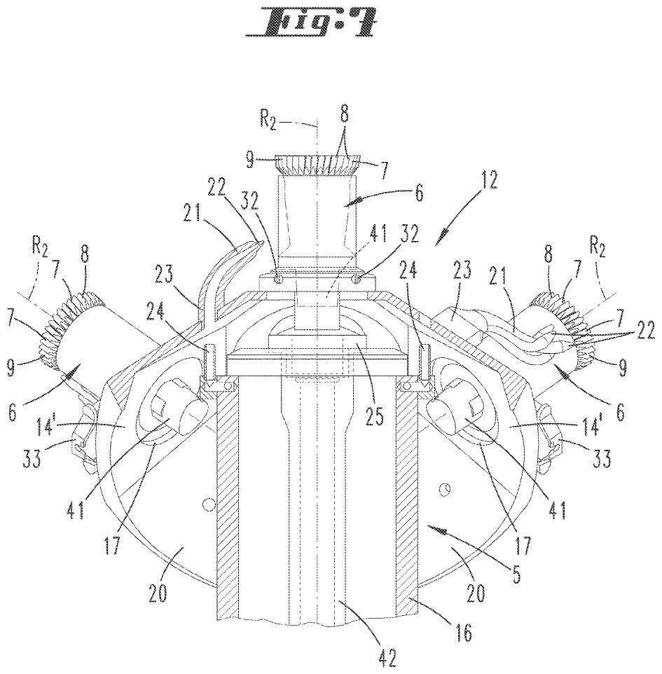

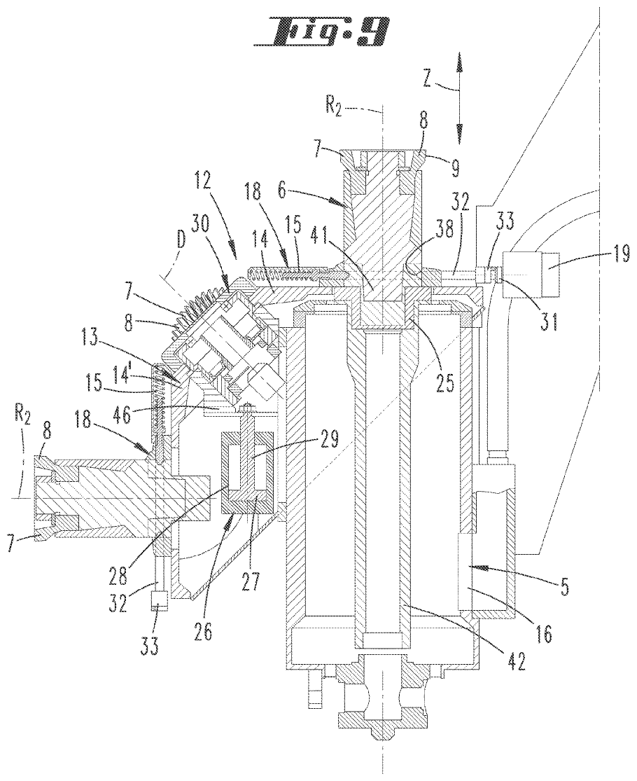

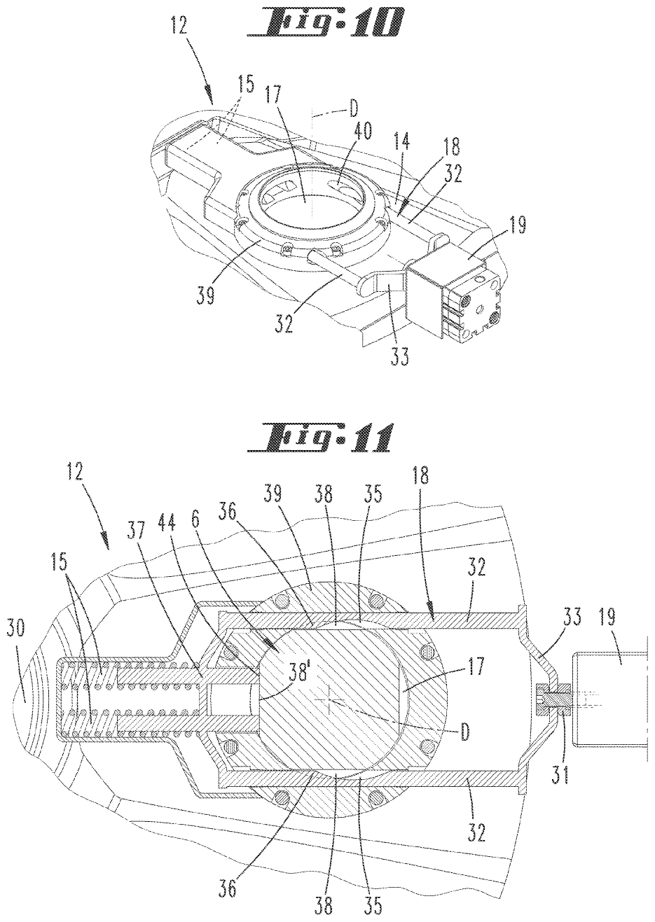

The tool changing system 12 has a tool carrier 13, which can be rotated about an axis of rotation D in relation to the guided section 46. This is done using a rotary drive 30. With the lifting device 26 described above, the tool carrier 13 can be shifted from the position shown in FIGS. 2, 9, in which a coupling section 41 of a tool retainer 6 is coupled to a chuck 25 of a drive shaft 42 and a coupling means 23 of a supplementary tool 21 is coupled to a counter coupling means 24 to a position shown in FIGS. 6 and 7, in which the coupling section 11 is not connected to the drive shaft 42 and the coupling means 23 is not connected to the counter coupling means 24 so that the tool carrier 13 can be rotated about the axis of rotation D. This is done in order to move another tool retainer 6 into a position in which the coupling means 23 can be coupled to the counter coupling means 24 and the coupling section 41 with the chuck 25 of the drive shaft 42 by means of a linear shifting of the lifting device 26.

The tool carrier 13 consists of carrying plates 14, 14′ arranged around a rotary drive 30, wherein intermediate plates 20 are arranged between the carrying plates 14, 14′. Carrying plates 14, 14′ and intermediate plates 20 extend to the lateral surfaces of a truncated pyramid. The axis of rotation D passes through the head surface of the truncated pyramid. Two carrying plates 14, 14′ opposite each other with respect to the axis of rotation D have an angle of 90 degrees to each other. The angle β by which the axis of rotation D is inclined with respect to the workpiece axis of rotation R1 is 45 degrees.

Each of the carrying plates 14, 14′ carries a holder for holding a tool retainer 6. The holder essentially consists of a guide ring 39 which is firmly fastened to the carrying plate 14 by screws or otherwise. The guide ring 39 forms guide channels in which locking elements 32 of a locking means 18 are guided. A circular opening of the guide ring 39 forms a bearing opening 17 into which the shaft of a tool retainer 6 can be inserted, which can be held there both axially fastened as well as non-rotatable with the locking means 18.

The intermediate plates 20, which extend between two adjacent carrying plates 14 and 14′, each carry a supplementary tool 21. In the exemplary embodiment, the supplementary tool 21 is a fluid nozzle 22, which can be used to move a fluid in the direction of the skiving tool 7. One foot of the supplementary tool 21 forms a coupling means 23, which can be coupled to a counter coupling means 24, which is firmly connected to the housing 16. In the exemplary embodiment, the coupling means 23 and the counter coupling means 24 are formed by a tube section that can be inserted into a sleeve section. A fluid supply line can thus be moved into a flow connection with the fluid nozzle 22.

The drive shaft 42 forms a chuck 25 into which a coupling section 41 of the tool retainer 6 can be inserted by means of a linear shifting of the tool carrier 13. During the course of this linear shifting, the coupling means 23 and the counter coupling means 24 also preferentially diverge into a coupling connection or, in the case of a linear shifting in the opposite direction, from a coupling position.

The guide ring 39 also simultaneously forms a fastener for attaching a locking means 18 to the tool carrier 13. The fastener has two parallel guide channels, each of which is guided by a bar 32 forming a locking element. The two rods can have a circular cross-section and form a blocking section 36, which can project through a window 40 into the free cross-sectional area of bearing opening 17. The shaft of the tool retainer 16 has a indentation 38 at this point with a bottom of 38′. The blocking section 36 is located in the locking position of the locking means 18 in this indentation 38. The bottom 38′ of the indentation 38 runs on a secant with respect to the axis of rotation R2.

The shaft of the tool retainer 6 has four indentations 38 arranged on a common plane, two of which are opposite indentations 38 in the movement trajectory of the locking elements 32.

One or two spring elements 15, formed in the exemplary embodiment by helical compression springs, are provided, which are supported by a housing floor of a housing, and which are impinged by a connecting bar 37, via which the two locking elements 32 are connected to each other. In addition, one or a plurality of stops 44 are fastened to the connecting bar 37, which enters against the bottom 38′ of a indentation 38 in the locking position in order to fix the tool retainer 6 in a torque-proof manner.

The locking means 18 can be moved from the locking position to a re

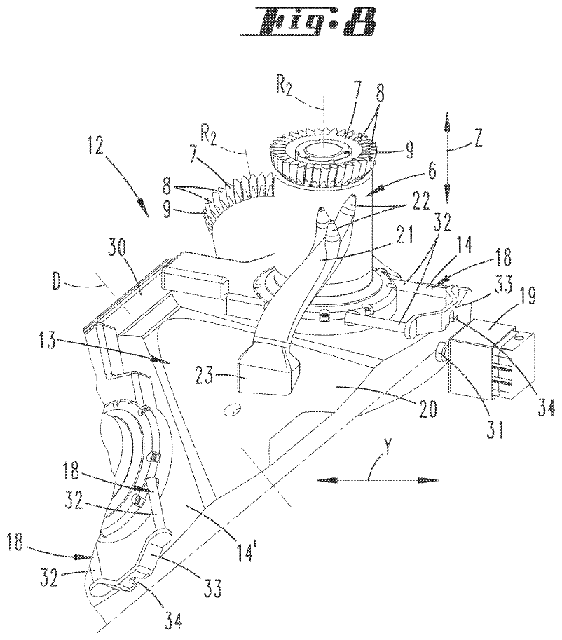

lease position by means of an actuating element 19. For this purpose, the actuating element 19 is firmly fastened to the housing 16 of the tool spindle 5, for example by means of an arm. In the exemplary embodiment, the actuating element 19 has a slider 31, which can be shifted in the direction of shifting of the locking elements 32. In the lowered position of the tool changing system 12, the slider 31 is coupled to the bracket 33. For this purpose, the bracket 33 forms a coupling recess 34. In the raised position (see FIG. 8) of tool carrier 13, bracket 33 is removed from the slider 31.

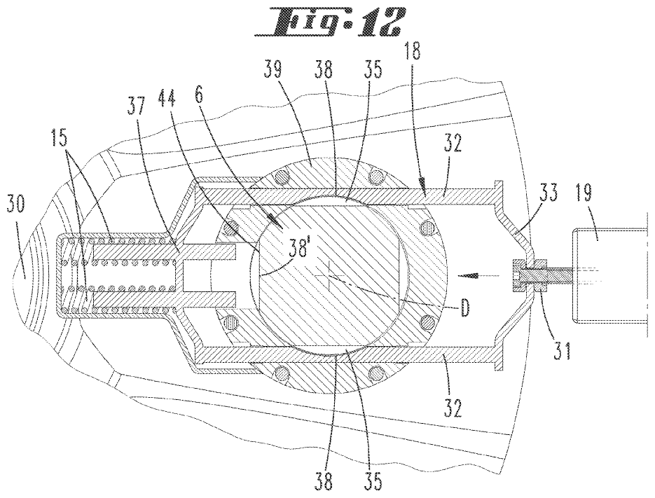

By shifting the slider 31 from the locking position shown in FIG. 11 to the release position shown in FIG. 12, the locking elements 32 are shifted linearly in such a way that two opposing free spaces 35 are located in windows 40 of the guide ring 39. The stop 44 has removed itself from the indentation 38 in this position. In this position, the tool retainer 6 can be rotated. However, it can also be removed from the bearing opening 17 to be exchanged for another tool retainer 6. The free spaces 35 have an arc shape, wherein the arc shape corresponds to a circular line and the circle line has a diameter equal to the diameter of the bearing opening 17.

In the exemplary embodiment, the tool carrier 13 is equipped with a total of four tool retainers 6, each of which carries different skiving tools 7. Other tool carriers 13 can be provided in which the carrying plates 14 have a different arrangement so that they comprise five or six bearing openings 17 each for a tool retainer 6.

For a tool change during the machining of one or a plurality of gears 4, the tool 7 can be changed by first removing the tool carrier 13 from the housing 16, i.e., by lifting it with a lifting device 26, wherein both the tool retainer 6 as well as the supplementary tool 21 are moved out of their respective coupling positions in conjunction with this movement. The tool carrier 13 can then be rotated about the axis of rotation D until a desired progressive tool has been moved into a position in which a tool retainer 6 machining the work wheel 3 had previously been. By moving the tool carrier 13 back close to the housing again, the tool retainer 6 and the supplementary tool 21 are moved back into a coupling position.

The rotation of the tool carrier 13 around the tool-carrier axis of rotation D can be carried out with an electrically operated rotary drive 30. This can have a stepper motor.

The aforementioned embodiments serve to explain the inventions covered by the application as a whole, which independently advance prior art by at least the following combinations of features, wherein two, a plurality of or all of these combinations of features can also be combined, namely:

A gear-cutting machine characterized by a tool changing system 12 fastened to a housing 16 of the tool spindle 2, which has a tool carrier 13 that can be rotated about a tool-carrier axis of rotation D with a plurality of carrying plates 14 rotatably arranged around the tool-carrier axis of rotation D, each of which has a bearing opening 17 for holding a tool retainer 6 carrying a skiving tool 7, wherein tool retainers 6 supported in the bearing openings 17 can be selectively coupled to the tool spindle 2 by means of rotation of the tool carrier 13 about the axis of rotation D.

A gear-cutting machine characterized in that the tool carrier 13 is designed like a truncated pyramid, the carrying plates 14 are formed by the lateral surfaces of the truncated pyramid and the axis of rotation D runs centrally and perpendicularly through a head surface of the truncated pyramid, wherein the axis of rotation D comprises such an angle of inclination β to the tool axis of rotation R2 that a surface extension of a carrying plate 14, which assumes a machining position, runs transversely to the tool axis of rotation R2 and/or that of the one or a plurality of tools 7 whose tool retainers 6 are each stuck in a bearing opening 17, at least one or all of them is/are a skiving tool.

A gear-cutting machine characterized in that the tool carrier 13 is designed like a truncated pyramid, the carrying plates 14 are formed by the lateral surfaces of the truncated pyramid and the axis of rotation D runs centrally and perpendicularly through a head surface of the truncated pyramid, wherein the axis of rotation D comprises such an angle of inclination β to the tool axis of rotation R2 that a surface extension of a carrying plate 14, which assumes a machining position, runs transversely to the tool axis of rotation R2.

A gear-cutting machine characterized in that a carrying plate 14′ that does not assume the machining position runs at a right angle to the carrying plate 14 assuming the machining position.

A gear-cutting machine characterized in that the tool changing system 12 for coupling the tool retainer 6 with the tool spindle 2 can be shifted in one direction of the tool axis of rotation R2.

A gear-cutting machine characterized in that the tool retainer 6 is temporarily fastened in the bearing opening 17 of the carrying plate 14 with detachable locking means 18, which locking means 18 can be shifted from a locking position to a release position by an actuating element 19 fastened to the housing 16 of the tool spindle 2.

A gear-cutting machine characterized in that locking means 18 comprises two parallel locking elements 32 which engage in a indentation 38 of the tool retainer 6 from the locking position and/or that the locking elements 32 of the locking means 18 comprise two opposing free spaces 35 through which the tool retainer 6 can be moved in an axial direction in the release position.

A gear-cutting machine characterized in that a stop 44 of the locking means 18 is supported in the locking position on the tool retainer 6 and/or that a spring element 15 in the locking position impinges a stop 44 of the locking means 18 into a indentation 38 of the tool retainer 6.

A gear-cutting machine characterized in that locking means 18 are actuated by a spring element 15 in their locking position.

A gear-cutting machine characterized in that at least one carrying plate 14 or an intermediate plate 20 adjacent to the carrying plate 14 carries a supplementary tool 21.

A gear-cutting machine characterized in that the supplementary tool 21 comprises a coupling means 23 which can be engaged with a counter coupling means 24 when coupling the tool retainer 6 to a chuck 25 of tool spindle 2.

A gear-cutting machine characterized in that the supplementary tool 21 is a fluid nozzle 22 by means of which a fluid, in particular, air or a cooling or rinsing fluid, can be moved against the work wheel 3 and that the coupling means 23 and the counter coupling means 24 are formed by a tube section that can be inserted into a sleeve.

A gear-cutting machine characterized in that one foot of the supplementary tool 21 formed by a tube is fastened to an intermediate plate 20.

A gear-cutting machine characterized by a lifting device 26 fastened to the housing 16 of the tool spindle 5, which shifts a thrust rod 29 parallel to the tool axis of rotation R2, by means of which a guided section 46 of the tool changing system 12 guided by a guide 45 fastened to the housing 16, which carries a rotary drive 30 of the tool changing system 12, can be shifted parallel to the tool axis of rotation R2.

A method which is characterized in that, between two machining steps, each of which involves machining of a gear, a first tool retainer 6, which carries a first tool 7, is exchanged for a second tool retainer 6, which carries a second tool 7, wherein the replacement of the tool retainers 6 is accompanied by a shifting of the tool carrier 13 in the direction of the tool axis of rotation R2 caused by the actuation of a lifting device 26 and an accompanying decoupling of the first tool retainer 6 from a chuck 25, a rotation of the tool carrier 13 about the tool-carrier axis of rotation D and a further shifting of the tool carrier 13 in the direction of the tool axis of rotation R3 initiated by the lifting device 26 and an accompanying coupling of the second tool retainer 6 with the chuck 25.

All disclosed features are essential to the invention (on their own, but also in combination with each other). In the disclosure of the application, the disclosure contents of the related/enclosed priority documents (copy of the pre-application) shall hereby be fully included, and also concerning this purpose, features of these documents must be included in claims of the present application. The sub-claims, even without the features of a referenced claim, characterize with their features independent inventive further embodiment of the prior art, in particular, in order to make divisional applications on the basis of these claims. The invention specified in each claim can additionally have one or a plurality of the features set out in the above description, in particular, those provided with reference numbers and/or specified in the reference-number list. The invention also relates to designs in which some of the features mentioned in the above description are not realized, in particular insofar as they are recognisably dispensable for the respective purpose or can be replaced by other technically identical means.

List of reference numbers

| | |
|---|---|
| 1 | workpiece spindle |
| 2 | workpiece chuck |
| 3 | work wheel |
| 4 | toothing |
| 5 | tool spindle |
| 6 | tool retainer |
| 7 | skiving tool |
| 8 | cutting tooth |
| 9 | cutting edge |
| 10 | holder |
| 11 | machine bed |
| 12 | tool changing system |
| 13 | tool carrier |
| 14 | carrying plate, in machining |
| | position |
| 14′ | carrying plate, not in machin- |
| | ing position |
| 15 | spring element |
| 16 | tool spindle housing |
| 17 | bearing opening |
| 18 | locking means |
| 19 | actuating element |
| 20 | intermediate plate |
| 21 | supplementary tool |
| 22 | fluid nozzle |
| 23 | coupling means |
| 24 | counter coupling means |
| 25 | chuck |
| 26 | lifting device |
| 27 | piston |
| 28 | cylinder |
| 29 | piston rod, thrust rod |
| 30 | rotary drive |
| 31 | slider |
| 32 | rod, locking slider |
| 33 | bar |
| 34 | recess |
| 35 | free space |
| 36 | blocking section |
| 37 | connecting bar |
| 38 | indentation |
| 38′ | bottom of indentation |
| 39 | guide ring |
| 40 | window |
| 41 | coupling section |
| 42 | drive shaft |
| 43 | pivoting device |
| 44 | stop |
| 45 | guide |
| 46 | guided section |

α axis intersection angle
β angle of inclination
D tool-carrier axis of rotation
R1 workpiece axis of rotation
R2 tool axis of rotation
S pivot axis

1. A gear-cutting machine designed as a skiving machine, comprising:
a workpiece spindle (1), which is configured to be rotationally driven, for holding a work wheel (3) to undergo gear cutting,
a tool spindle (2) that is configured to be rotationally driven synchronously with the workpiece spindle and which is configured for holding a tool retainer (6), wherein the workpiece spindle (1) is arranged at an axis intersection angle (α) inclined in relation to the tool spindle (2),
a tool changing system (12) fastened to a housing (16) of the tool spindle (2), the tool changing system comprising a tool carrier (13) that is configured to be rotated about a tool-carrier axis of rotation (D), the tool carrier having a plurality of carrying plates (14) that are rotatably arranged around the tool-carrier axis of rotation (D), each of carrying plate having a bearing opening (17) configured for holding a tool retainer (6) carrying a tool (7), wherein tool retainers (6) supported in the bearing openings (17) are configured to be selectively coupled to the tool spindle (2) by means of rotation of the tool carrier (13) about the axis of rotation (D).

2. The gear-cutting machine according to claim 1 wherein the tool carrier (13) is in the shape of a truncated pyramid, the carrying plates (14) are formed by lateral surfaces of the truncated pyramid and the axis of rotation (D) runs centrally and perpendicularly through a head surface of the truncated pyramid, wherein the axis of rotation (D) comprises an angle of inclination (α) to the tool axis of rotation (R2) such that a surface extension of a carrying plate (14), which assumes a machining position, runs transversely to the tool axis of rotation (R2) and/or wherein of the one or a plurality of tools (7) whose tool retainers (6) are each stuck in a bearing opening (17), and wherein at least one of the tools is a skiving tool.

3. A gear-cutting machine comprising:
a rotatable workpiece spindle (1) configured for holding a work wheel (3) to undergo gear cutting,
a tool spindle (2), which tool spindle (2) is configured to be rotationally driven synchronously with the workpiece spindle (1) for holding a tool retainer (6),
a tool changing system (12) fastened to a housing (16) of the tool spindle (2), and comprising a tool carrier (13) that is configured to be rotated about a tool-carrier axis of rotation (D) with a plurality of carrying plates (14) that are rotatably arranged around the tool-carrier axis of rotation (D), each carrying plate having a bearing opening (17) configured for holding a tool (7) with a tool retainer (6), wherein the tool retainers (6) supported in the bearing openings (17) are configured to be selectively coupled to the tool spindle (2) by means of rotation of the tool carrier (13) about the axis of rotation (D),
wherein the tool carrier (13) is in the shape of a truncated pyramid, the carrying plates (14) are formed from lateral surfaces of the truncated pyramid and the tool carrier axis of rotation (D) is centered and runs perpendicular through a head surface of the truncated pyramid, wherein the tool carrier axis of rotation (D) comprises an angle of inclination (β) to the tool axis of rotation (R2) such that a surface extension of a carrying plate (14), which assumes a machining position, runs transversely to the tool axis of rotation (R2).

4. The gear-cutting machine according to claim 2, wherein a carrying plate (14′) of the carrying plates which does not assume a machining position runs at a right angle to a carrying plate (14) of the carrying plates assuming the machining position and/or wherein the tool changing system (12) configured for coupling the tool retainer (6) with the tool spindle (2) is replaceable in one direction of the tool axis of rotation (R2).

5. The gear-cutting machine according to claim 1, wherein at least one of the tool retainers (6) is temporarily fastened in the respective bearing opening (17) of the carrying plate (14) with detachable locking means (18), which locking means (18) are configured to be shifted from a locking position to a release position by an actuating element (19) fastened to the housing (16) of the tool spindle (2).

6. The gear-cutting machine according to claim 5, wherein the locking means (18) comprises two parallel locking elements (32) which engage in an indentation (38) of the tool retainer (6) from the locking position and/or wherein the locking elements (32) of the locking means (18) comprise two opposing free spaces (35) through which the tool retainer (6) can be moved in an axial direction in the release position.

7. The gear-cutting machine according to claim 5, wherein a stop (44) of the locking means (18) is supported in the locking position on the tool retainer (6) and/or wherein a spring element (15) in the locking position impinges a stop (44) of the locking means (18) into an indentation (38) of the tool retainer (6).

8. The gear-cutting machine according to claim 5, wherein the locking means (18) are actuated by a spring element (15) in their locking position.

9. The gear-cutting machine according to claim 2, wherein at least one of the carrying plates (14) or an intermediate plate (20) adjacent to the at least one carrying plate (14) carries a supplementary tool (21).

10. The gear-cutting machine according to claim 9, wherein the supplementary tool (21) comprises a coupling means (23) which is configured to be engaged with a counter coupling means (24) when coupling the tool retainer (6) to a chuck (25) of tool spindle (2).

11. The gear-cutting machine according to claim 9, wherein the supplementary tool (21) is a fluid nozzle (22) by means of which a fluid can be moved against the work wheel (3) and wherein the coupling means (23) and the counter coupling means (24) are formed by a tube section that is configured to be inserted into a sleeve.

12. The gear-cutting machine according to claim 9, wherein a foot of the supplementary tool (21) formed by a tube is fastened to an intermediate plate (20).

13. The gear-cutting machine according to claim 2, further comprising a lifting device (26) fastened to the housing (16) of the tool spindle (5), the lifting device being configured to shift a thrust rod (29) parallel to the tool axis of rotation (R2), by means of which a guided section (46) of the tool changing system (12) guided by a guide (45) attached to the housing (16), which carries a rotary drive (30) of the tool changing system (12), can be shifted parallel to the tool axis of rotation (R2).

14. A method for the manufacture of internal or external toothed gears (3) with a gear-cutting machine according to claim 1, comprising:
two machining steps involving,
between the two machining steps, exchanging a first tool retainer (6) of the tool retainers, which carries a first tool (7), for a second tool retainer (6) of the tool retainers, which carries a second tool (7), wherein the step of exchanging is accompanied by a shifting of the tool carrier (13) in the direction of the tool axis of rotation (R2) caused by the actuation of a lifting device (26) and an accompanying decoupling of the first tool retainer (6) from a chuck (25), a rotation of the tool carrier (13) around the tool-carrier axis of rotation (D) and a further shifting of the tool carrier (13) in the direction of the tool axis of rotation (R2) initiated by the lifting device (26) and an accompanying coupling of the second tool retainer (6) with the chuck (25).

15. (canceled)
